(19) United States
(12) Patent Application Publication
(10) Pub. No.: US 2003/0186021 A1
(43) Pub. Date: Oct. 2, 2003

(54) Loop fastener member superior in durability

(75) Inventors: Takaaki Tanaka, Osaka (JP); Yukitoshi Higashinaka, Fukui-Pref. (JP); Takashi Katayama, Okayama-Pref. (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KURARAY CO., LTD., Okayama-Pref. (JP)

(21) Appl. No.: 10/372,915

(22) Filed: Feb. 26, 2003

(30) Foreign Application Priority Data
Feb. 26, 2002 (JP) 2002-049671

(51) Int. Cl. B32B 33/00; D05C 17/00; B32B 3/02; D04H 11/00

(52) U.S. Cl. 428/97; 428/99; 428/96; 428/92

(57) ABSTRACT

A loop fastener member having loop fastening elements rising from a base fabric exhibits good durability when the loop fastening elements contain polyamide fibers in which from 60 to 100 mol % of the dicarboxylic acid units of the polyamide are aromatic dicarboxylic acid units and from 60 to 100 mol % of the diamine units are C₆₋₁₂ aliphatic diamine units. The loop fastening elements sink down little or deform even after washing and wet heat pressure treatment at high temperatures.

### BACKGROUND OF THE INVENTION

1. Field of the Invention

The present invention relates to a separable fastener that comprises a large number of loop fastening elements formed to rise from a woven or knitted base fabric.

2. Discussion of the Background

Separable fasteners in which hook fastening elements and loop fastening elements are engaged with each other to form fastening have been utilized in various applications.

The use of such separable fasteners is expanding these days. In one example, a separable fastener of looped fastening elements (hereinafter referred to as a “loop fastener member”) is formed in linen such as bed sheets; quilt covers, pillowcases and sofa covers, while the other separable fastener of hooked fastening elements (hereinafter referred to as a “hook fastener member”) is formed on the surface of the bodies to be covered with such linen, such as beds, quilts, pillows and sofas, and the hook fastening elements are engaged with the loop fastening elements to thereby fix the covers to the bodies. This embodiment is now gaining importance.

In the field of such applications, the covers are repeatedly washed and ironed. Therefore, the loop fastening elements of the loop fastener member fitted to the covers must be flexible and resistant to deformation stress. However, when the covers with conventional loop fastener members fitted thereto are repeatedly ironed, or subjected to wet heat treatment under pressure at around 150° C., the loop fastening elements formed to rise from the base fabric of the covers are greatly deformed to an unrestorable degree. This results in a falling down or sinking down of the loop fastening elements to the base fabric. They cannot be restored to their original condition, and the engaging force is significantly lowered.

To solve the problem, for example, a loop fastener member is proposed in JP-A 7-308727, in which the loop fastening elements are formed of a mixture of monofilaments and multifilaments.

In many cases, loop filaments are formed of fibers of nylon 6 or nylon 66. However, these nylon fibers are not resistant to heat, causing the above-mentioned problems. Accordingly, in JP-A 11-253209, a loop fastener member is proposed in which the loop fastening elements are formed of polytrimethylene terephthalate fibers, a type of polyester fibers. However, even this loop fastener member is still problematic in that its restorability from thermal deformation is unsatisfactory and the engaging force is greatly lowered through repeated ironing.

### SUMMARY OF THE INVENTION

It is therefore an object of the present invention to provide a loop fastener member that is superior in durability to wet-heat pressure treatment at high temperatures.

This and other objects have been achieved by the present invention the first embodiment of which includes a loop fastener member, comprising:

loop fastening elements rising from a base fabric;

wherein said loop fastening elements comprise polyamide fibers in which from 60 to 100 mol % of the dicarboxylic acid units of the polyamide are aromatic dicarboxylic acid units and from 60 to 100 mol % of the diamine units are C₆₋₁₂ aliphatic diamine units.

### DETAILED DESCRIPTION OF THE INVENTION

The present inventors have found that, when specific polyamide fibers are used for forming loop fastening elements, then a loop fastener member resistant to ironing can be obtained.

Specifically, the present invention is a loop fastener member that comprises loop fastening elements rising from a base fabric which are formed of polyamide fibers. From 60 to 100 mol % of the dicarboxylic acid units of the polyamide fibers are aromatic dicarboxylic acid units and from 60 to 100 mol % of the diamine units of the polyamide fibers are C₆₋₁₂ aliphatic diamine units. The amount of aromatic dicarboxylic acid units of the polyamide fibers includes all values and subvalues therebetween, especially including 65, 70, 75, 80, 85, 90 and 95 mol %. The amount of C₆₋₁₂ aliphatic diamine units includes all values and subvalues therebetween, especially including 65, 70, 75, 80, 85, 90 and 95 mol %.

Preferably, the polyamide principally comprises the above-mentioned aromatic dicarboxylic acid units and the above-mentioned aliphatic diamine units, and at least 10% of its terminal groups are blocked. More preferably, the polyamide satisfies an additional condition: when measured in concentrated sulfuric acid at 30° C., its intrinsic viscosity [η] is from 0.4 to 3.0 dl/g. The intrinsic viscosity of the polyamide includes all values and subvalues therebetween, especially including 0.6, 0.8, 1.0, 1.2, 1.4, 1.6, 1.8, 2.0, 2.2, 2.4, 2.6 and 2.8 dl/g.

Preferably, the polyamide contains at least 75 mol %, more preferably at least 85 mol % and most preferably at least 95 mol % of aromatic dicarboxylic acid units as dicarboxylic acid units; from the viewpoint of the wet heat resistance and the engaging force and also the mechanical properties of the loop fastener member. The aromatic dicarboxylic acid includes, for example, terephthalic acid; isophthalic acid; sodium sulfoisophthalate; 2,6-naphthalenedicarboxylic acid; 2,7-naphthalenedicarboxylic acid; 1,4-naphthalenedicarboxylic acid; 1,4-phenylenedioxydiacetic acid; 1,3-phenylenedioxydiacetic acid; diphenic acid; 4,4′-oxydibenzoic acid; diphenylmethane-4,4′-dicarboxylic acid; diphenylsulfone-4,4′-dicarboxylic acid; and 4,4′-biphenyldicarboxylic acid. Preferred are terephthalic acid and 2,6-naphthalenedicarboxylic acids and more preferred is terephthalic acid. More preferably, at least 80 mol % of the aromatic dicarboxylic acid is terephthalic acid; and most preferably, the aromatic dicarboxylic acid is substantially terephthalic acid alone.

Dicarboxylic acids other than the aromatic dicarboxylic acid are, for example, aliphatic dicarboxylic acids such as malonic acid; dimethylmalonic acid; succinic acid; 3,3-diethylsuccinic acid; glutaric acid; 2,2-dimethylglutaric acid; adipic acid; 2-methyladipic acid; trimethyladipic acid; pimelic acid; azelaic acid; sebacic acid; suberic acid; and alicyclic dicarboxylic acids such as 1,3-cyclopentanedicarboxylic acid, and 1,4-cyclohexanedicarboxylic acid. One or more dicarboxylic acid units selected from these may be introduced into the polyamide as copolymer units. In addition, a polycarboxylic acid having three or more functional groups such as trimellitic acid, trimesic acid or pyromellitic acid may also be in the polyamide within a melt-spinnable range.

In addition, from 60 to 100 mol % of the diamine units of the polyamide for use in the invention must be C₆₋₁₂ aliphatic diamine units. Preferably, the polyamide contains at least 75 mol %, more preferably at least 90 mol % of C₆₋₁₂ aliphatic diamine. The C₆₋₁₂ aliphatic diamine units include those derived from aliphatic diamines such as 1,6-hexanediamine; 1,8-octanediamine; 1,9-nonanediamine; 1,10-decanediamine; 1,12-dodecanediamine; 2-methyl-1,5-pentanediamine; 3-methyl-1,5-pentanediamine; 2,2,4-trimethyl-1,6-hexanediamine; 2,4,4-trimethyl-1,6-hexanediamine; 2-methyl-1,8-octanediamine and 5-methyl-1,9-nonanediamine. Above all, preferred are 1,9-nonanediamine units in view of the deformation resistance and the durability of the loop fastener member; and more preferred is a combination of 1,9-nonanediamine units and 2-methyl-1,8-octanediamine units. In the combination, the molar ratio of 1,9-nonanediamine units to 2-methyl-1,8-octanediamine units preferably falls between 9/1 and 1/9 including all values and subvalues therebetween. More preferably, the 1,9-nonanediamine units and 2-methyl-1,8-octanediamine units accounts for at least 80 mol % of the C₆₋₁₂ aliphatic diamine units.

Examples of diamines other than the C₆₋₁₂ aliphatic diamines are aliphatic diamines such as ethylenediamine, propylenediamine, tetramethylenediamine, pentamethylenediamine; alicyclic diamines such as cyclohexanediamine, methylcyclohexanediamine, isophoronediamine, and aromatic diamines such as p-phenylenediamine, m-phenylenediamine, xylylenediamine, xylenediamine, 4,4′-diaminodiphenylmethane, 4,4′-diaminodiphenyl sulfone, 4,4′-diaminodiphenyl ether. Preferably, at least 10%, more preferably at least 40%; most preferably at least 70% of the terminal groups of the molecular chain of the polyamide are blocked with a terminal blocking agent. If the degree of terminal blocking of the polyamide for use in the invention is less than 10%, the fibers formed may be discolored and their strength may be unsatisfactory. The degree of terminal blocking of the polyamide can be determined by counting the number of the terminal carboxyl groups, the number of the terminal amino groups and the number of the terminal groups blocked with a terminal blocking agent. It is desirable that, in view of its accuracy and simplicity, the number of the terminal groups is obtained by ¹H-NMR spectroscopy, by separately integrating the characteristic signals corresponding to the terminal groups.

Without being specifically limited, the terminal blocking agent may be any and every monofunctional compound reactive with the amino group or the carboxyl group of the polyamide terminal. In view of their reactivity and the stability of the terminals blocked with them, preferred are monocarboxylic acids such as typically benzoic acid and monoamines; and more preferred are monocarboxylic acids as they are easy to handle. Apart from the above-mentioned compounds, also usable are acid anhydrides such as phthalic anhydride; monoisocyanates, mono-acid halides monoesters; and monoalcohols.

The polyamide for use in the present invention may be produced in any known method and the method is not specifically limited. For example, it may be produced through solution polymerization or interfacial polymerization of starting materials of acid chlorides and diamines, or through melt polymerization solid-phase polymerization or melt-extrusion polymerization of starting materials of dicarboxylic acids and diamines.

Preferably, the polyamide has, as the index of its molecular weight, an intrinsic viscosity [η] of from 0.6 to 2.0 dl/g, more preferably from 0.6 to 1.8 dl/g, most preferably from 0.7 to 1.5 dl/g measured in concentrated sulfuric acid at 30° C. Having the intrinsic viscosity falling within the range, the melt spinnability of the polyamide is good, and, in addition, the mechanical properties of the fibers to be made of it are good and the durability of the loop fastener member formed of the fibers is further improved.

If desired, the polyamide fibers to constitute the loop fastener member may contain colorants such as dye, pigment; and various stabilizers such as typical antioxidants and light stabilizers. In addition, their surfaces may be coated with a chemical having the ability to improve the lubricity of the fibers.

The loop fastener member of the present invention is formed of the polyamide fibers mentioned above, and the fiber diameter may be from 20 to 100 μm. The fiber diameter includes all values and subvalues therebetween, especially including 30, 40, 50, 60, 70, 80, and 90 μm. More preferably, however, for increasing the deformation resistance of the loop fastening elements without worsening the feel of the loop fastener member, from 10 to 90 single fibers each having a fiber diameter of from 40 to 90 μm are bundled up into multifilaments for forming the loop fastening elements. The loop fastening elements-forming fibers are woven along with the other weft and warp to constitute the base fabric of the loop fastener member, and then back-coated and heat-set in an ordinary manner, and the process gives the loop fastener member of the invention. Further, the other weft and warp may be formed of the above-mentioned specific polyamide, or may be formed of any other polyamide fibers, polyester esters, other synthetic fibers, natural fibers, regenerated fibers, etc. Regarding their height, it is desirable that the loop fastening elements rise from the face of the base fabric by from 1 to 5 mm or so for preventing them from being deformed in wet heat pressure treatment. The height of the loop fastening elements includes all values and subvalues therebetween, especially including 1.5, 2, 2.5, 3, 3.5, 4 and 4.5 mm.

The present invention relates to a loop fastener member. This loop fastener member is not meant to indicate a loop fastener member of loop fastening elements alone but includes a hook-and-loop coexisting fastener that comprises both loop fastening elements and hook fastening elements formed on one and the same base fabric. This means that the loop fastener member of the invention encompasses any and every type of fastener member having loop fastening elements formed on a base fabric.

The loop fastener member of the present invention has good durability and is especially favorable for clothing. In addition, the loop fastener member of the present invention has high engaging force, and it is usable not only for clothing, but also for bed sheets, quilt covers, pillowcases, sofa covers, etc.

Having generally described this invention, a further understanding can be obtained by reference to certain specific examples which are provided herein for purposes of illustration only, and are not intended to be limiting unless otherwise specified.

### EXAMPLES

The physical properties of the samples in the invention were measured methods mentioned below:

Intrinsic Viscosity [η] of Polyamide:

A sample having a predetermined concentration in concentrated sulfuric acid at 30° C. was measured to obtain its inherent viscosity [ηinh]. Its data were extrapolated to a concentration 0, and the resulting value is the intrinsic viscosity [η] of the sample.

ηinh=[1n(t₀/t₀)]/c

wherein ηinh indicates the inherent viscosity (dl/g) of the sample; t₀ indicate the flow down time (sec) of the solvent; t₁ indicates he flow down time (sec) of the sample solution; and c indicates the sample concentration (g/dl) in the solution.

Durability to Wet Heat Pressure Treatment:

A loop fastener member (width 25 mm, length 100 mm) was sewed on a cotton fabric (mass per unit area 200 g/m²) to prepare a sample.

The sample was put into a domestic washing machine, and room-temperature tap water was put thereinto to have a bath ratio according to the of 1:50. Further, a weak-alkaline synthetic detergent (Lion's Top (trade name)) was added to it in a ratio of 1 g/liter. This was continuously washed for 1 hour, then rinsed for 5 minutes and dewatered through centrifugation for 5 minutes. Next, the sample was pressed with a Hoffman hot presser at 150° C. for 5 minutes. This washing and pressing operation was one cycle. The sample was subjected to a predetermined number of the cycles. The engaging force of the loop fastener member of the sample was measured, tried with a hook fastener member (this comprises hook fastening elements of polyester monofilaments, having a fiber diameter of 0.20 mm, a height of the fastening elements of 1.80 mm, and a density of the fastening elements of 40/cm²). The engaging force was measured according to the method of JIS-L-3416, in which the peeling strength and the tensile shearing strength of the sample were measured.

### Example 1

A dicarboxylic acid component of terephthalic acid was polymerized with a diamine component of 1,9-nonanediamine and 2-methyl-1,8-octanediamine (molar ratio, 1:1) along with a terminal blocking agent of benzoic acid to obtain a polyamide having a degree of terminal blocking of 90% and an intrinsic viscosity [η] of 0.8 dl/g.

The resulting polyamide was melt-spun into polyamide multifilaments having a fineness of 230 dtex/10 filaments (diameter of each fiber: 48 μm). These were looped on a base fabric of polyester multifilaments of 167 dtex/48 filaments for both the warp and the weft to fabricate a loop fastener member having a loop height of 2.89 mm and a loop density of 60 loops/cm².

The durability of the thus obtained loop fastener member was evaluated according to the method mentioned above. Engaging force of the sample before washed and the engaging force thereof after 5 cycles were measured according to the above-mentioned method, and the force retention was obtained. The results are given in Table 1.

### Comparative Example 1

A loop fastener member was fabricated, for which the loop yarn was polyester multifilaments having a fineness of 267 dtex/10 filaments and the warp and the weft of the base fabric were polyester multifilaments of 167 dtex/48 filaments. The loop height was 2.59 mm, and the loop density was 60 loops/cm². This was repeatedly washed and hot-pressed in the same manner as in Example 1, and its engaging force was measured. In addition, the engaging force retention was also evaluated. The results are given in Table 1.

### Comparative Example 2

A loop fastener member was fabricated, for which the loop yarn was nylon-6 multifilaments having a fineness of 230 dtex/10 filaments and the warp and the weft of the base fabric were nylon-6 multifilaments of 156 dtex/12 filaments. The loop height was 2.47 mm, and the loop density was 60 loops/cm². This was repeatedly washed and hot-pressed in the same manner as in Example 1, and its engaging force was measured. In addition, the engaging force retention was also evaluated. The results are given in Table 1.

### Comparative Example 3

A loop fastener member was fabricated, for which the loop yarn was nylon-66 multifilaments having a fineness of 300 dtex/16 filaments and the warp and the weft of the base fabric were nylon-66 multifilaments of 149 dtex/34 filaments. The loop height was 2.65 mm, and the loop density was 60 loops/cm². This was repeatedly washed and hot-pressed in the same manner as in Example 1, and its engaging force was measured. In addition, the engaging force retention was also evaluated. The results are given in Table 1.

TABLE 1

| | Tensile | | | |
|---|---|---|---|---|
| | Shearing Strength | | Peeling Strength | |
| | (kg/cm²) | | (g/cm) | |
| | | after 5 cycles | | after 5 cycles |
| | before | (force | | (force |
| | washed | retention, %) | before washed | retention, %) |
| Example 1 | 1.23 | 0.84 | 154 | 120 |
| | | (68.3) | | (77.9) |
| Comparative | 1.37 | 0.30 | 169 | 68 |
| Example 1 | | (21.9) | | (40.2) |
| Comparative | 1.16 | 0.50 | 129 | 86 |
| Example 2 | | (43.1) | | (66.7) |
| Comparative | 1.20 | 0.61 | 157 | 100 |
| Example 3 | | (50.8) | | (63.7) |

### Example 2

A hook-and-loop coexisting fastener was fabricated, for which the warp and the weft of the base fabric were nylon-6 multifilaments having a fineness of 150 dtex/12 filaments, the loop yarn was the polyamide multifilaments used in Example 1, and the hook yarn was nylon-66 monofilaments having a fineness of 430 dtex. Thus obtained, the hook-and-loop coexisting fastener had a hook height of 2.05 mm, a hook density of 30 hooks/cm², a loop height of 2.45 mm, and a loop density of 40 loops/cm². This was washed in the same manner as in Example 1, and its engaging force was measured. The results are given in Table 2.

### Comparative Example 4

A hook-and-loop coexisting fastener was fabricated in the same manner as in Example 2, for which, however, the loop yarn was nylon-6 multifilaments having a fineness of 230 dtex/10 filaments. This was washed in the same manner as in Example 2, and its engaging force was measured. The results are given in Table 2.

TABLE 2

| | Tensile | | | |
|---|---|---|---|---|
| | Shearing Strength | | Peeling Strength | |
| | (kg/cm²) | | (g/cm) | |
| | | after 5 cycles | | after 5 cycles |
| | before | (force | | (force |
| | washed | retention, %) | before washed | retention, %) |
| Example 2 | 1.25 | 0.92 | 140 | 120 |
| | | (73.6) | | (85.7) |
| Comparative | 1.20 | 0.79 | 130 | 98 |
| Example 4 | | (65.8) | | (75.4) |

As described in detail hereinabove with reference to its preferred embodiments, the present invention provides a loop fastener member of good durability; in which the loop yarn sinks down little even in washing and wet heat pressure treatment at high temperatures.

Japanese patent application 49671/2002, filed Feb. 26, 2002, is incorporated herein by reference.

Numerous modifications and variations on the present invention are possible in light of the above teachings. It is therefore to be understood that within the scope of the appended claims, the invention may be practiced otherwise than as specifically described herein.

1. A loop fastener member, comprising:
loop fastening elements rising from a base fabric;
wherein said loop fastening elements comprise polyamide fibers in which from 60 to 100 mol % of the dicarboxylic acid units of the polyamide are aromatic dicarboxylic acid units and from 60 to 100 mol % of the diamine units are C₆₋₁₂ aliphatic diamine units.

2. The loop fastener member according to claim 1, wherein at least 10% of the terminal groups of said polyamide are blocked.

3. The loop fastener member according to claim 1, wherein said polyamide has an intrinsic viscosity of from 0.4 to 3.0 dl/g, as measured in concentrated sulfuric acid at 30° C.

4. The loop fastener member according to claim 1, wherein said polyamide comprises units obtained from an aromatic dicarboxylic acid selected from the group consisting of terephthalic acid; isophthalic acid; sodium sulfoisophthalate; 2,6-naphthalenedicarboxylic acid; 2,7-naphthalenedicarboxylic acid; 1,4-naphthalenedicarboxylic acid; 1,4-phenylenedioxydiacetic acid; 1,3-phenylenedioxydiacetic acid; diphenic acid; 4,4′-oxydibenzoic acid; diphenylmethane-4,4′-dicarboxylic acid; diphenylsulfone-4,4′-dicarboxylic acid; and 4,4′-biphenyldicarboxylic acid.

5. The loop fastener member according to claim 1, wherein said polyamide comprises one or more non-aromatic dicarboxylic acid units.

6. The loop fastener member according to claim 1, wherein said polyamide comprises a polycarboxylic acid.

7. The loop fastener member according to claim 1, wherein said polyamide comprises units obtained from 1,6-hexanediamine; 1,8-octanediamine; 1,9-nonanediamine; 1,10-decanediamine; 1,12-dodecanediamine; 2-methyl-1,5-pentanediamine; 3-methyl-1,5-pentanediamine; 2,2,4-trimethyl-1,6-hexanediamine; 2,4,4-trimethyl-1,6-hexanediamine; 2-methyl-1,8-octanediamine or 5-methyl-1,9-nonanediamine.

8. The loop fastener member according to claim 1, wherein said polyamide comprises a combination of 1,9-nonanediamine units and 2-methyl-1,8-octanediamine units.

9. The loop fastener member according to claim 1, wherein said polyamide comprises an alicyclic diamine or an aromatic diamine.

10. The loop fastener member according to claim 2, wherein a blocking agent is a monofunctional compound reactive with an amino group or a carboxyl group of a terminal of said polyamide.

11. The loop fastener member according to claim 1, further comprising a colorant, a stabilizer or a mixture thereof.

12. The loop fastener member according to claim 1, a surface of which is coated with a chemical having the ability to improve the lubricity of said polyamide fibers.

13. The loop fastener member according to claim 1, wherein said polyamide fibers have a fiber diameter of from 20 to 100 μm.

14. The loop fastener member according to claim 1, comprising from 10 to 90 single fibers each having a fiber diameter of from 40 to 90 μm bundled up into multifilaments.
